(19) United States
(12) Patent Application Publication
(10) Pub. No.: US 2004/0126017 A1
(43) Pub. Date: Jul. 1, 2004

(54) Grammar-determined handwriting recognition

(76) Inventors: Giovanni Seni, Mountain View, CA (US); Fabio Valente, Manduria (IT); Guo Jin, Sunnyvale, CA (US)

Correspondence Address: VEDDER PRICE KAUFMAN & KAMMHOLZ, 222 N. LASALLE STREET, CHICAGO, IL, 60601, US

(21) Appl. No.: 10/334,049

(22) Filed: Dec. 30, 2002

(51) Int. Cl. G06K 9/72; G06K 9/18

(52) U.S. Cl. 382/229; 382/186

(57) ABSTRACT

A system (10) for recognizing handwriting includes an input/output device (12) and a second computer (24 or 28). The system (10) converts handwritten symbols to text by using a grammar (50) that is comprised of the text (60) that is expected to be entered into a text display/text input area (17) of an input/output device (12). The grammar (50) and handwriting-to-text conversion can be performed in either the input/output device (12) or a remote computer (24, 28).

### BACKGROUND OF THE INVENTION

The increased availability of small keyboardless Personal Information Appliances (PIAs) with touch screens and wireless communication capabilities has renewed interest in pen-based user interfaces. A pen-based user interface is enabled by a stylus and a transducer device that captures the movement of the stylus as digital ink. The “digital ink” can then be passed on to recognition software that will convert the pen input into appropriate computer actions, preferably recognizing in the digital ink, text or other information that was intended to be input to the PIA.

Pen-based interfaces are desirable in mobile computing because they are scalable. Only small reductions in size can be made to keyboards before they become awkward to use; however, if they are not shrunk in size, they lose their portability. Keyboard scalability is even more problematic as mobile devices develop into multimedia terminals with numerous functions ranging from agenda and address book to wireless web browser.

Voice-based interfaces may be a solution, but voice commands they require entail problems that mobile phones already have introduced in terms of disturbing bystanders and loss of privacy. Furthermore, using voice commands to control applications such as a web browser can be difficult and tedious. In contrast, clicking on a link with a pen, or entering a short text by writing, is more natural and takes place in silence and more privately.

Like voice recognition, handwriting recognition is inherently ambiguous. Consider the similarity between the two words “Ford” and “Food”. Distinguishing the two words by a computer is problematic because of the similarity between the two words. If a handwriting recognition engine were expecting the name of a car manufacturer, then “Ford” would be the correct interpretation.

For many applications in PIA devices—e.g., contacts, agenda, and web browser, it is possible to pre-specify the words or characters that can be entered in certain data fields. Examples of structured data fields are telephone numbers, zip codes, city names, dates, times, URLs. etc. Currently, no differentiation is made between text input that is made by a keyboard and that using handwriting recognition; that is, applications in a PIA are, for the most part, not aware of the recognition process. Processing handwritten input symbols to reduce input ambiguity would be an improvement over the prior art.

### BRIEF DESCRIPTION OF THE DRAWINGS

FIG. 1 depicts a system for recognizing handwriting.

FIG. 2 depicts an input/output device for recognizing handwritten input symbols entered into an input area that are expected in a text display area.

FIG. 3 depicts an alternate embodiment of an input/output device for recognizing handwritten input symbols entered into an input area that are expected in a text display area.

FIG. 4 depicts a system for recognizing handwriting, and the signals sent between a server and an input/output device.

FIG. 5 shows an input/output device for recognizing handwriting.

FIG. 6 depicts the function of a handwriting recognition engine which uses a grammar to process and recognize handwritten input signals.

FIG. 7 an input/output device displaying a list of text recognized in a handwritten input symbol

### DETAILED DESCRIPTION OF THE PREFERRED EMBODIMENT

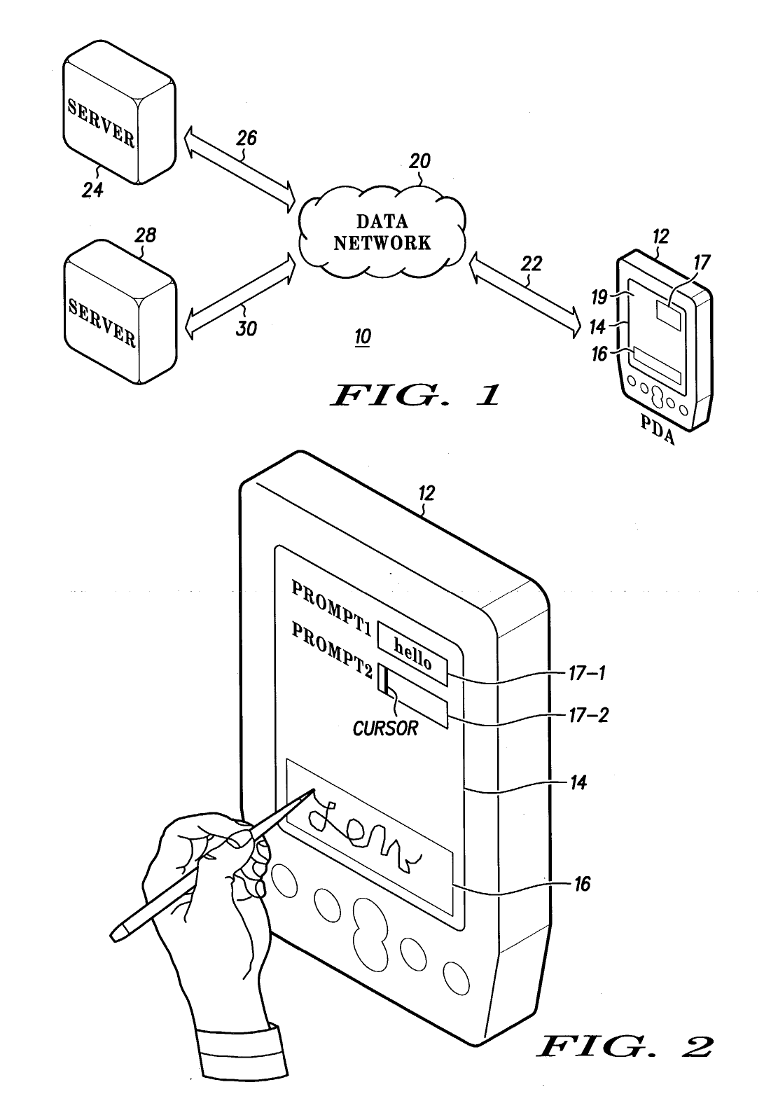

FIG. 1 shows a system 10 for performing grammar-determined handwriting recognition. The system 10 is comprised of an input/output device 12 which has a touch-sensitive input pad 14 into which handwritten input symbols can be entered in a touch-sensitive handwriting-input area 16. The handwritten symbols input into the input area 16 are recognized and converted to text using a grammar that is determined by the text that is expected to entered in a text display/text input area 17. The text display/text input area 17 is so called because text that is displayed in the text display/text input area 17 can also be sent to, or input, to other programs, processes or computer as input text or strings.

The text that is expected in the text display/text input area 17 can be solicited, prompted or suggested by text, symbols, icons or other information in a prompt field 19, shown in FIG. 1 adjacent to the text display/text input area 17. FIG. 2 shows a prompt string “PROMPT 1” adjacent a first text display/text input area 171; it also shows a prompt string “PROMPT 2” adjacent to a second, text display/text input area 17-2.

The input/output device 12 can be embodied as a personal digital assistant, a notepad computer, or other device onto which handwritten symbols can be made and converted into signals or data that represent the handwritten symbols. Such an input/output device 12 includes at least one processor, which is not shown in FIG. 1 for clarity. The input/output device 12 and any associated processor of it should be capable of executing a program by which handwritten symbols can be converted to text using a grammar. In an alternate embodiment, the processor should be capable of sending the electrical signals and/or data representing handwritten input symbols to another computer, such as remote server, that processes the handwritten input symbols into text that the remote server expects to be entered into a text display/text input area 17 and which returns the recognized text to the input/output device 12 for display thereon.

Handwritten symbols are entered in the touch-sensitive hand-writing input area 16. The touch-sensitive input pad 14 on which the handwritten input symbols are entered or written, converts the input symbols into electrical signals or data, which are then sent to a computer or microcontroller (not shown in FIG. 1) whereat the electrical signals that represent the handwritten input symbols are processed to recognize in them. The electrical signals that represent handwritten input symbols are processed to recognize in the handwritten.

In one embodiment, the processing of handwritten input symbols to recognize text takes place within the input/output device 12. In another embodiment, the processing of handwritten input symbols to recognize text takes place in a remote or second computer, such as one or both of the servers 24 and 28 depicted in FIG. 1.

In either embodiment, the text that is recognized in a handwritten input symbol is displayed in the text display/text input area 17 but it can also be sent to another application, process or computer as input data. In so doing, the handwritten input symbol recognition processing can function as a substitute for a keyboard by which text strings would otherwise have to be manually entered. An example of the use of the handwriting recognition processing for use an input device would be to function as an input for an HTML generated form, which can be generated by one of the servers 24, 28.

In the embodiment shown in FIG. 1, the input/output device 12 is operatively coupled to a wide-area data network 20 via a data link 22. Those of skill in the art know that the Internet is a wide-area data network. The servers 24 and 28 are also coupled to the wide area network 20 via data links 26 and 30 respectively.

The data links 22, 26 and 30 can be provided by any appropriate medium instances of which include plain old telephone service, a cable television network, wireless data transmission or other mechanisms by which data signals can be exchanged between the input/output device 12, the data network 20 and other computers that are also coupled to the data network 20. The precise nature of the data link 22 is not critical to an understanding of the invention disclosed and claimed herein.

In the embodiment wherein input symbol recognition processing takes place within the input/output device 12, handwritten input symbols to the input/output device 12 are recognized within the input/output device 12 by the input/output device's 12 use of “grammar.” The “grammar” by which handwritten input symbol recognition is improved is determined by the text that is expected to be input into the text display area 17. “Text” that is expected to be entered into the display area or field 17 can include letters, numbers or symbols. The scope or nature of the text that is expected in a display area or field 17 can be identified or prompted by text or symbols that are displayed in a prompt field 19, which is shown in FIG. 1 to be adjacent to the text display/text input area 17. Text that is recognized in a handwritten input symbol is displayed in the display area 17, but can also be sent to another computer program (i.e., an “application”).

By way of example, if a numeric date is expected to be entered into the display area 17, computer program instructions and data provided to and used by the computer within the input/output device 12 will prefer to recognize handwritten input symbols entered into the handwriting input area 16 as numeric dates.

In an alternate embodiment, the input/output device 12 acts as a client to one or more remote servers 24 and 28. In such an embodiment, one or more remote servers 24 and/or 28 receives from the input/output device 12, the electrical signals that represent a handwritten input symbol that was entered into a handwriting input area 16, hereafter referred to as “digital ink.” Upon receipt of the digital ink, the server that received the digital ink (i.e., the server which retains the grammar) processes the digital ink and converts it to one or more strings of text that expected by the server to be entered into a text display/text input area 17 and that are likely to conform to the grammar associated with the text display/text input area 17. The server performs the handwriting recognition using the grammar of text that is expected to be entered into the text display/text input area 17, sends the text to the input/output device 12 for display in the display area 17 and can also send the text as input data to any other computer program or application as input information.

The grammar that is used to recognize text in digital ink is preferably embodied as one or more data files or data structures by which the computer in either the input/output device 12 or a server correlates the digital ink to strings of text that are expected to be entered into one or more display areas. This correlation is done by a handwriting recognition engine, which can reside in either the input/output device 12 or in a second computer 24 or 28 and which classifies the handwritten input symbols as one of the strings that can be generated from grammar rules 50 by which text is recognized in handwriting. Accordingly, the grammar determines the range of input symbols that can be recognized and the grammar is in turn defined by the text that is expected to be entered albeit in the form of handwritten input symbols.

FIG. 2 shows the input/output device 12 of FIG. 1 in greater detail. In FIG. 2, one or more handwritten input symbols, such as one or more printed or cursively-formed letters, numbers or other stylus strokes can be entered into a touch-sensitive, handwriting input area 16. The handwriting input area 16 is a software-demarcated input area 16 into which handwritten symbols are to be entered, such as by using a stylus or pen.

Handwritten input symbols that are entered into the handwriting input area 16 is processed to recognize in those symbols, text that is expected to be entered into at least one of the two text display/text input areas 17-1 and 17-2. “PROMPT 1” is a text message, icon or other message suggesting or identifying the nature of the text that is expected in text display/text input area 17-1. “PROMPT 2” is a text message, icon or other message suggesting or identifying the nature of the text that is expected in text display/text input area 17-2. As shown in FIG. 1, the text string “hello” is displayed in the output display area 17-1 illustrating that a previously-entered handwritten symbol that was entered into the input area 16 was recognized as the string “hello.” The string “hello” would have been defined by the grammar for text display/text input area 17-1 as a string that was expected to be entered into the text display/text input area 17-1. Text display/text input area 17-2 can have its own grammar by which handwritten input symbols entered into the input area 16 are processed into text that is expected to be entered into the text display/text input area 17-2

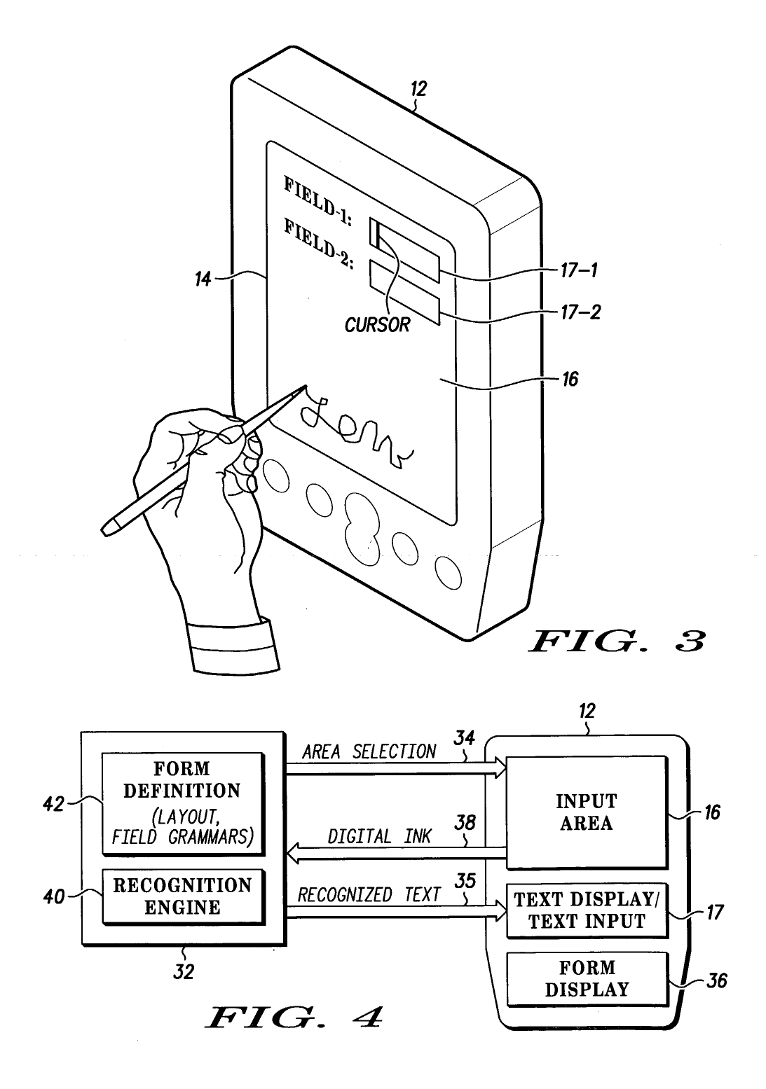

FIG. 3 shows another embodiment of an input/output device 12. The entire touch-sensitive input pad 14 functions as an input area 16 into which one or more handwritten input symbols can be entered. Like the input/output device shown in FIG. 2, in FIG. 3, handwritten input symbols written into the touch-sensitive input pad 14 are processed to recognize in them, text that is expected to be entered into one of the text display/text input areas 17-1 and 17-2 by using a grammar for the particular field 17-1 or 17-2.

The embodiments of input/output device 12 depicted in FIGS. 2, and 3 are equivalent in that they each have at least one, touch-sensitive, handwriting input area into which one or more handwritten input symbols can be entered. They each have at least one text display/text input area 17 where text that was recognized in a handwritten input symbol can be displayed. The text that is recognized in a handwritten input symbol for a particular display area 17 can be forwarded to another computer, computer program or other device or process as input data in the form of ASCII data.

For any embodiment of input/output device, as shown in FIG. 2 or 3, the input/output device 12 can be operatively coupled to a second computer such as a server via wide-area data network 20 and a data link 22. Using such an embodiment, as set forth above, digital ink from the handwriting input area can be delivered to a second computer for the handwriting recognition. The digital ink sent to a second computer can be processed to recognize in the digital ink, a text string that the second computer expects to be entered into a text display/text input area 17 on the input/output device 12.

The input field 16 into which text is to be entered will have a grammar that defines or delimits the text that is expected to be entered into each text display/text input area 17. In instances where an input/output device 12 display multiple text display/text input areas 17-1 and 17-1 as shown in FIGS. 2 and 3, the handwriting input field 16 can have different grammars for each text display/text input area 17 and the computer that performs the recognition processing needs to know the particular field 17-1 or 17-2 that a handwritten input symbol was entered, in order to use the appropriate grammar. The field into which an input symbol is to be entered is preferably selected (i.e., given “focus” or made active) by way of a separate input signal to the input/output device 12, such as by a separate input symbol or selecting an icon. Inasmuch as the text display areas 17-1 and 17-2 really display text that was recognized in handwriting and that can also be sent to a computer, computer program or other device or process as “input” information, the display areas 17-1 and 17-2 are, as stated above, also considered to be text “input fields.”

After a text input field 17-1 or 17-2 is identified, as set forth above, a handwritten symbol entered into the handwriting input area 16 is converted into the aforementioned “digital ink.” The digital ink is processed by the computer within the input/output device or a second computer to recognize text embodied within the digital ink. The generation of electrical signals that represent a handwritten input symbol is well-known to those of skill in the art and omitted for clarity.

In some cases, the computer that processes the digital ink (whether such as computer is within the input/output device 12 or a server 24, 28) might not be able to definitely convert the digital ink to text. In such a case, the computer processing the digital ink will generate a list of text strings that are considered to correspond to an input symbol that the grammar defines to be valid. A user can then manually select the text that was ostensibly entered by a handwritten input symbol, further insuring accurate entry.

FIG. 4 depicts information flow between an input/output device 12 and a second computer 32, such as one of the servers depicted in FIG. 1. In FIG. 4, a server or second computer 32 sends information 34 to the input/output device 12 that specifies or defines a handwriting input area 16 on the touch-sensitive input pad 14 of the input/output device 12 into which a handwritten input symbol is to be entered on the touch sensitive input pad 14. The information 34 that specifies an input area 16 can specify vertices on a display pad 14 into which a handwritten input symbol should be made. For purposes of claim construction, “handwritten input symbol” should be construed to include one or more strokes, marks, or icon selections on a touch-sensitive input pad, representing an information input. In embodiments that process handwritten input symbols within the input/output device 12, the second computer 32 can also send one or more files to the input/output device that comprise a grammar for each input text field 17 (also referred to as the “text display/text input areas”). The grammar for an input text field 17 is used by the input/output device 12 to convert or recognize handwritten input symbols entered into the handwriting input area 16 into one or more strings of recognized text 35 which the input/output device 12 shows or echoes into the text fields 17.

In embodiments of the input/output device 12 that do not process handwritten input symbols within the input/output device 12, the input/output device 12 will send the aforementioned digital ink 38 to the second computer 32. In such an embodiment, the information 38 returned to the server 32 will include an indicator of a selected input text field 17-1 or 17-2 that a user selected for entering text via handwriting to be entered into the input area 16, which can be important if different input text fields 16 and 18 use different grammars to recognize handwritten input symbols.

Upon the selection of an input text field 17-1 or 17-2, the input/output device 12 returns to the second computer 32, information 38 that specifies which field was selected. The information 38 sent to the second computer 32 can include the aforementioned digital ink.

In embodiments of the input/output device 12 that do not process handwritten input symbols into text, software within the second computer 32 includes a recognition engine 40, embodied as a computer program that correlates handwritten input symbols into text strings that are expected by the second computer 32 to be entered into the selected text display/text input area 17. In converting the digital ink into text, the second computer 32 will use a grammar that defines the text that was expected by the second computer to be entered into the display area 17-1 or 17-2. Upon processing the handwritten input symbol into one or more text strings, the second computer 32 will send the recognized text string(s) back to the input/output device 12 for display at the text field that was active or had the focus. The second computer 32 can also use the text that was recognized in the handwritten input symbol as input to another program or send the recognized text to another computer for other uses.

FIG. 5 depicts functional components of the input/output device 12. The output/output device 12 has a computer 44, such as a microprocessor, microcontroller, digital signal processor or other finite state machine that is operatively coupled to a touch-sensitive input device or input pad 14.

The computer 44 is also coupled to an output display device 21 the function of which is to echo handwritten inputs to a user and to display text strings, such as prompts, but also to display text strings that were recognized from handwritten input symbols. In many embodiments, the output device 21 will include the functionality of the input pad 14 in a single display window, such as the input and display devices commonly used in PDAs.

The input device 14 is preferably a touch-sensitive input screen that permits the specification of at least one area 16 into which handwritten input symbols can be made. The input/output device 12 shown in FIG. 1 can have one, two or more text display/text input fields in the output device 21 which specify the text that needs to be entered into a handwriting input area 16 of the input device 14.

Coupling the computer 44 to a second computer 32 can be accomplished a number of ways, including the Internet Protocol, which is well-known to those of skill in the art. Of course, appropriate hardware, software and transmission paths are required to accomplish a coupling between the computer 44 and the compute 32, however, data transmission between computers is well-known and not necessary to an understanding of the invention disclosed and claimed herein.

In embodiments where the input/output device 12 performs the task of handwriting recognition, the information that the computer 44 can receive from the server 32 includes one or more grammars 46, which the computer 44 will use to identify, i.e., recognize handwritten input symbols as text that is expected in one or more text display/text input areas 17. The grammar 46, which is preferably embodied as data structures and/or data files, is used to identify handwritten input symbols by matching or correlating the signals and/or data that represents a handwritten input symbol to data that represents text that is expected to be entered into a particular input area.

By way of example, if the text display/text input fields or areas 17 are expected to receive as inputs, certain strings of characters, such as license plate numbers, the grammar 46 sent to the input/output device 12 computer 44 would include a computer representation of a rule defining valid license plate numbers—e.g., “cccddd” to indicate that a string of length 6 is expected, the first three symbols of which should be characters and the last three digits. Accordingly, the grammar 46 defines or specifies the recognizability of handwritten input symbols into corresponding text strings.

In the embodiment shown in FIG. 5, the computer 44 includes a software recognition engine 48 which performs the function of converting the handwritten input symbols to text. The grammar information 46 that is downloaded into the input/output device 12 enables the input/output device 12 to perform the recognition function locally, i.e. within and by the device 12 and without the intervention or service of the remotely located server 32.

It should be noted, that the grammar 46 which defines or specifies expected text in the input fields is an expectation of the text that the second computer expects to be entered into the input fields. In other words, by downloading different grammars 46, the server 32 determines or specifies what sort of handwritten input symbols will be recognized by the recognition engine 48 and thereby specifies which handwritten symbols will be converted to text and what that recognized output text strings can be.

By having the server 32 effectively specify or determine what handwritten symbols will be recognized and the text to which they will be converted, the remote server 32 can exercise significant control over the recognition process. In instances where two or more text display/text input areas/text input areas 17-1 and 17-1 are represented on the input/output device 12, each area 17-1 and 17-2 can have its own grammar, but each grammar for each field will define the text that is expected to be entered into each field.

If more than one grammar 46 is downloaded, the computer 44 can select the appropriate grammar for a particular input field upon the user's selection of an input field 16 or 18 by either a stylus or soft key or key pad entry (a tab key press). Thereafter the computer 44 can perform the recognition function by the recognition engine 48 using the appropriate grammar. When the computer 44 recognizes input text, the computer 44 presents the recognized text on the output display device 15 as the converted text in the text fields having focus, where the user can confirm or reject the text strings that were ostensibly input as one or more handwritten input symbols.

In embodiments where the recognition engine is located at a second computer, the grammar and the function of performing the recognition will be performed at the second computer, precluding the need for downloading a grammar.

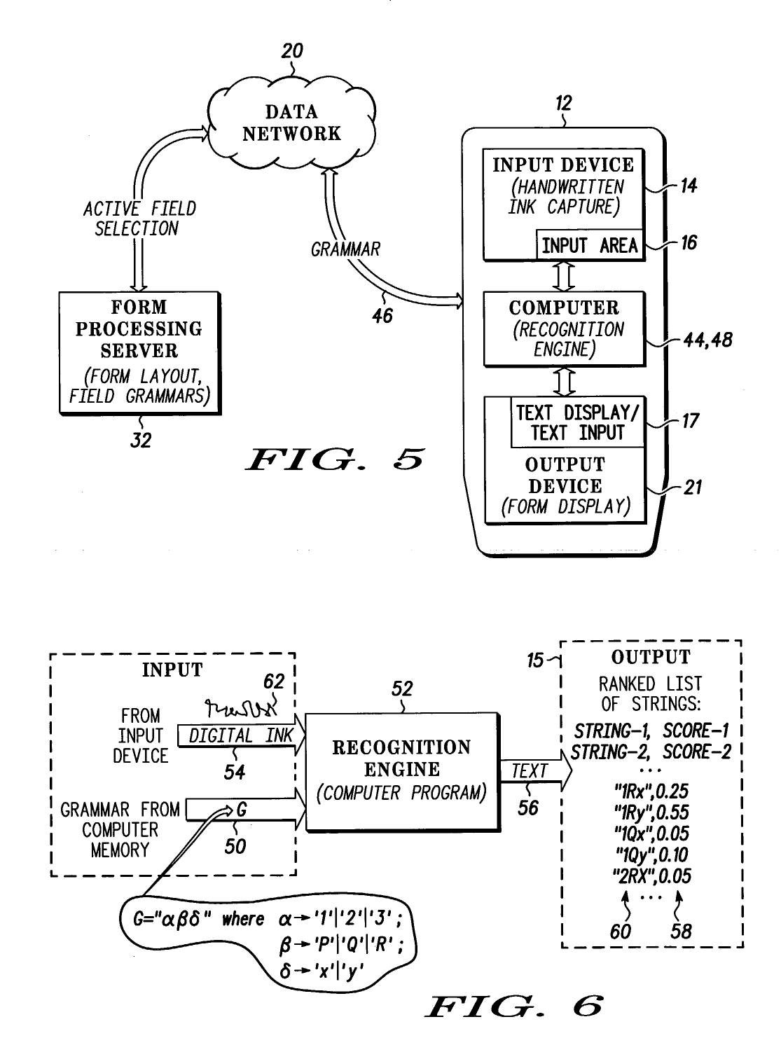

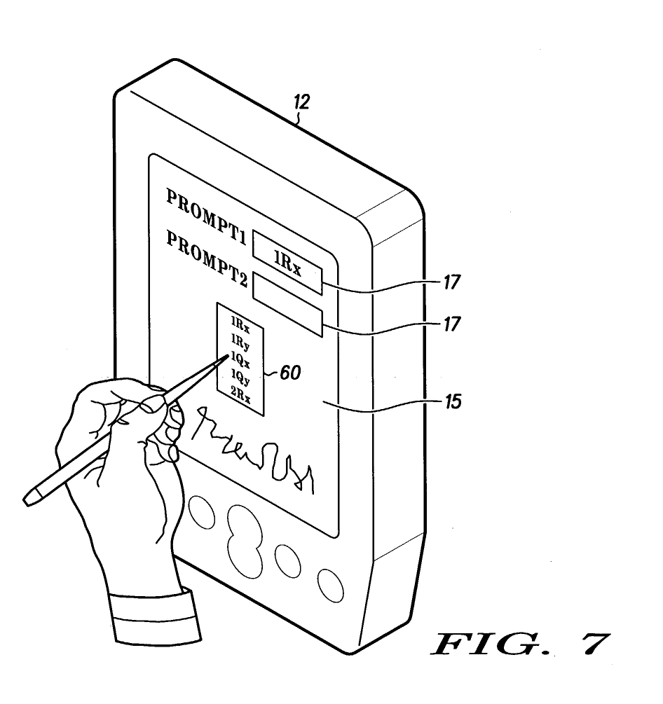

FIG. 6 depicts the handwriting input symbol, recognition engine function 52, which as stated above, can be performed in either a remote computer/server or within the input/output device 12. As set forth above, the recognition engine 52 is embodied as a computer program executing on an appropriately capable processor. The recognition engine compares digital ink 54 (which is an electrical representation of handwritten input symbols 62) to a grammar 50 and determines whether the handwritten input symbol 62 corresponds to text that is expected to be entered into a text display/text input area 17.

The grammar 50 is typically embodied as one or more data files or data structures which contain information representing valid recognition results that can be generated by the recognition engine in response to some handwritten input symbol.

Regardless of the robustness of the recognition engine computer program 52, some handwritten input symbols might not be capable of perfect recognition, usually because of the irregularities in a handwritten input symbol. Accordingly, as shown in FIG. 6, the recognition engine 52 will generate a list 60 of ostensibly recognized output text strings, albeit prioritized or sorted 58 according to the likelihood of correspondence between a recognized text string and the handwritten input symbol.

When the recognition engine 52 receives the grammar 50 and receives the handwritten input symbols 62 as digital ink 54, it processes those two quantities to generate results, each of which represents a text string that is considered to be valid by the recognition engine according to the grammar 50. The processing of the digital ink 54 to recognize text is by way of the grammar 50. Inasmuch as absolute certainty is rarely accomplished, the recognition engine will generate an ordered list of resulted text strings, and in a preferred embodiment, a numeric score 58, indicative of the likelihood of correspondence of the text string 60 to a handwritten input symbol 62.

If the grammar G as shown in FIG. 6 is defined as having three constituent elements, alpha, beta and gamma, where the elements of alpha are “1”, “2” and “3” and the set of elements for beta is an “P”, “Q” and “R” with gamma being either “X” or “Y” the input string or symbol identified in FIG. 6 by reference numeral 62 can be processed by the recognition engine 52 into at least 18 (3×3×2) different potential outputs. The five possible output strings 60 shown in the list have a numeric score 58 assigned to each potential output string the value of which indicates the likelihood of correspondence of the recognized output text string 60 to the input symbol 62.

In FIG. 7, the recognition engine 52 causes the display of each of the recognized output strings 60 and their numeric scores 58 on an output display 15 of the input/output device 12. In so doing, the recognition engine 52 enables a user of the input/output device 12 to select from the list, the text string that best-represents the handwritten input symbol 62.

Upon computing the ranked list of strings and their numeric scores, on the output device of the input/output device 12, the system depicted in FIG. 1 can enable the display of a list of likely conversions and a manual selection of an output text string that best-represents the conversion of the handwritten input symbol.

The manual selection of a text string can be accomplished if the display string is output onto the input display device in such a fashion that a text-sensitive display screen can be used to select a particular output text string.

In a preferred embodiment, the input/output device 12 recognizes handwriting on a touch-sensitive input pad using a grammar that is downloaded into the input/output device 12 from a remote computer, such as a server. In such an embodiment, the recognition engine software executes on the computer that is resident within the input/output device 12. In an alternate embodiment, a remote server or computer 24 or 28 for instance, can download to the input/output device 12, only the information required to define or establish the text input fields and handwriting input area into which handwritten symbols are to be entered. In this alternate embodiment, the input/output device merely collects the handwritten input symbols and converts them into electrical signals that represent those handwritten input symbols. The converted handwritten input symbol information is returned to the remote server whereat a recognition engine uses a grammar stored within the server to perform the handwriting recognition. Upon the conversion process, the server can return to the input/output device 12, the text string into (an possibly the other alternate results) which the handwritten input symbol is converted. The input/output device can then display on the local display device, the text string that was generated by the conversion process.

In each embodiment, the grammar used to perform handwriting recognition defines text that is expected to be entered into an input area. Accordingly, the grammar determines the vocabulary or set of symbols that are recognizable.

In the embodiment shown in FIG. 1, the grammar can be sent to the input/output device 12 for use locally within the input/output device 12 or, the grammar can remain resident in the remote servers. In instances where the recognition engine is within the input/output device 12, the recognition process is performed within the input/output device 12 although the text to be converted, is determined by the text that is expected by the remote server to be entered into a particular field that is displayed on the input/output device. In instances where the text recognition is performed remotely, i.e. the recognition engine remains in the remote servers, text can be entered into the input/output device but the expected text that which is defined by the grammar resident on the server.

If bears mentioning that the servers depicted in FIG. 1 include within them, at least one processor or other computer which execute program instructions by which they are able to perform handwriting recognition. The servers, as shown in FIG. 1 are coupled to a data network 20 by which they receive signals from remote input/output devices 12. The signals sent to the servers, and received by them via the data network are electrical signals that represent handwritten input symbols in one embodiment, or the electrical signals sent to the servers represent text that corresponds to input symbols that were recognized by recognition engines within the input/output devices 12.

In at least one of the foregoing embodiments, the servers send information to the input device that specifies one or more input fields into which text can be entered. As set forth above, the servers select a grammar for a particular input field and do so upon a user's selection of a text field for an input.

In embodiments where the server retains the recognition engine, they receive input symbols that represent the captured input symbols and using locally available grammars, process these input symbols that were captured into text strings.

Those of ordinary skill in the art of the HyperText Markup Language will recognize that the language supports the creation and presentation of forms, which are used to take input from a user at a web page. The definition of a form is enclosed within the tags <form> and </form>.

One of the most basic elements of a form is text input. Text input corresponds to text in the “text display/text input area” identified by reference numeral 17. An HTML text input declaration takes the form of: <input type=“text” name=“myYearTextBox” size=“2” maxlength=“4”> where “name” is a unique name within the form, “size” is the size of the box when rendered, and “maxlength” is the maximum number of characters or digits that can be typed into the box. If an input area is to include data (to which the user could add, modify, or delete completely) one would use the op!ti!onal value=“your data” attribute. For example, to have the current year displayed within the box, one could use a definition such as: <input type=“text” name=“myYearTextBox” size=“2” maxlength=“4” value=“2002”>.

In an HTML document, an element must receive focus from the user in order to become active and perform its tasks. For example, users must place the cursor in the entry area associated with an<input> element in order to give it focus and be able to start entering text into it. When an HTML element receives focus, an “onfocus” event is generated and an action can be triggered in the browser rendering the HTML page. A separate program such as a JavaScript typically carries out the desired action. Each <input> element in the form can have a separate action to execute when an onfocus event is received for it; the name of the program to execute is given as the value of an onfocus attribute—e.g., <input type=“text” name=“myYearTextBox” size=“2” maxlength=“4” value=“2002” onfocus=“MyJavaScript”>.

Using HTML, the idea of making an encoding of the expected text to be entered within a given field (i.e., the grammar associated with that field) available to the recognition engine, can be implemented by having a JavaScript that writes the Uniform Resource Identifier (URI) of the grammar—i.e., the address of the grammar on a network, to a pre-specified location accessible to the recognition engine. An example would then look like: <input type=“text” name=“myYearTextBox” size=“2” maxlength=“4” value=“2002” onfocus=“MyJavaScript(<http://www.A.mot.com/year.xml> http://www.mot.com/year.xml)”>, where “year.xml” is the grammar file defining valid years and which is assumed to be located in the server “www.mot.com”, and MyJavaScripto is a program that writes its argument to a pre-specified place. The recognition engine can them retrieve the grammar and use it during ink interpretation.

By defining a grammar or context by which handwritten input symbols will be processed into text, the likelihood of an accurate recognition is increased significantly. If a handwritten input symbol is expected to be the name of an automobile manufacturer, the license plate number, or a medical condition, a recognition engine that operates to convert handwritten symbols into text, can increase the likelihood of an accurate conversion by limiting the set of expected input symbols and the output strings to which they are likely to correspond. For purposes of claim construction therefore, “grammar” should be considered to include a context in which a handwritten input symbol is entered. Certain words will have meanings that are determined by the setting in which they are used, or a product or service they identify, or a message or meaning they are intended to convey. Accordingly, the recognition will convert handwritten input symbols to text strings that are pertinent or relevant to the circumstances or surroundings in which an expected text string is being used.

What is claimed is:

1. A system for recognizing handwriting comprised of:
an input/output device having:
a first computer;
an input pad operatively coupled to said first computer on which a handwritten input symbol can be made and converted to a first signal representing the handwritten input symbol, said first signal being input to the first computer;
an output display device operatively coupled to said first computer on which graphics can be displayed, said first computer receiving information from a second computer that specifies at least one input area on said input pad into which a handwritten symbol is to be entered and specifying a text display/text input area, said first computer sending the first signal to said second computer;
a second computer operatively coupled to said input/output device, said second computer sending information to said input/output device that specifies at least one input area into which a handwritten input symbol is to be entered, said second computer receiving the first signal from said input/output device, said second computer converting the handwritten input symbol entered into said input area to text using a grammar that is determined by text that said second computer expects to be entered in said text display/text input area.

2. The system of claim 1 wherein said information sent to said input/output device is information that specifies a plurality of text display/text input areas, one or more text display/text input areas each having a grammar for defining the text expected for the one or more areas.

3. The system of claim 2 wherein the second computer is a computer that selects the grammar for a particular text display/text input area upon a user's selection at said input/output device of the text display/text input area for input.

4. The system of claim 1 wherein the second computer is a computer that sends a handwritten input symbol captured in the input pad and the selected grammar, to a handwriting recognition engine for interpretation of the handwritten input symbol.

5. The system of claim 4 wherein the handwriting recognition engine receives a grammar and receives a handwritten input symbol as digital ink, and from said digital ink and grammar the handwriting recognition engine generates an ordered list of results, each result being a text string that is considered valid by the recognition engine according to the grammar.

6. The system of claim 5 wherein said handwriting recognition engine is comprised of a processor that assigns a numeric score to the results in said ordered list of results, said numeric score being indicative of the likelihood of the correspondence of the text string to the handwritten input symbol.

7. The system of claim 6 wherein the second computer selects for display in a text display/text input area on the input/output device that was previously selected at the input/output device, the text string having the greatest likelihood of correspondence to the handwritten input symbol.

8. The system of claim 5 wherein the second computer enables the display of said list and a manual selection of a text string from said list for display.

9. A system for recognizing handwriting comprised of:
an input/output device having:
a first computer;
an input pad operatively coupled to said first computer and having at least one input area into which handwritten input symbols can be made;
an output display screen having a text display/text input area, said output display screen being operatively coupled to said first computer;
said first computer receiving grammar information from a second computer that includes a grammar of text expected to be entered into said text display/text input area, the grammar being used to convert to text, handwritten input symbols entered into the at least one input area, said first computer sending to a second computer, text that is identified from said handwritten input symbols using the received grammar;
a second computer operatively coupled to said input/output device, said second computer sending information to said input/output device that specifies the at least one input area into which handwritten input symbols are to be entered, said second computer receiving text from said input/output device.

10. The system of claim 9 wherein said information sent to said input/output device specifies a plurality of text display/text input areas, one or more text display/text input areas having a grammar for defining the text expected for the one or more areas.

11. The system of claim 9 wherein the second computer is a computer that selects the grammar for a particular text display/text input area upon a user's selection of the text display/text input area for input.

12. The system of claim 9 wherein the second computer is a computer that sends handwritten input symbols captured in the input area and the selected grammar, to a handwriting recognition engine for interpretation of the handwritten input symbols.

13. The system of claim 9 wherein the handwriting recognition engine receives a grammar and receives handwritten input symbols as digital ink, and from said digital ink and grammar the handwriting recognition engine generates an ordered list of results, each result being a text string that is considered valid by the recognition engine according to the grammar.

14. The system of claim 9 wherein said handwriting recognition engine assigns a numeric score to the results in said ordered list of results, said numeric score being indicative of the likelihood of the correspondence of the text string to the handwritten input symbol.

15. The system of claim 9 wherein the first computer selects for display in the text display/text input area that was previously selected, the text string having the greatest likelihood of correspondence to the handwritten input symbol.

16. The system of claim 9 wherein the first computer enables the display of said list and a manual selection of a text string from said list for display.

17. An input/output device for recognizing handwriting comprised of:
a touch-sensitive input pad on which handwritten input symbols can be made;
an output display screen having a text display/text input area on which text can be displayed;
a first computer, operatively coupled to said touch-sensitive input pad and to said output display screen, said first computer being capable of sending signals to and receiving signals from a second computer via a data link;
said input/output device being capable of receiving information from a second computer that specifies at least one input area on said touch-sensitive input pad into which a handwritten input symbol is to be entered, said input/output device also being capable of sending a first signal to the second computer that represent a handwritten input symbols entered onto the touch-sensitive input pad, whereby the second computer upon receiving the first signal, converts a handwritten input symbol entered into said input area to text, by using a grammar that is determined by text that is expected by the second computer to be entered in said text display/text input area.

18. The input/output device of claim 17 further comprised of an output display screen that receives from at least one of the first computer and the second computer, a second signal that represents the text to which said computer converted the handwritten input symbol.

19. The input/output device of claim 17 wherein the information sent to said input/output device from said second computer specifies a plurality of text display/text input areas, one or more input areas having a grammar for defining the text expected for the one or more areas.

20. The input/output device of claim 17 wherein the first computer of the input/output device includes a first computer that selects the grammar for a particular text display/text input areas upon a user's selection of the text display/text input area for input.

21. The input/output device of claim 20 wherein the first computer sends handwritten input symbols captured in the input area and the selected grammar, to a handwriting recognition engine in said second computer for interpretation of the handwritten input symbols.

22. The input/output device of claim 21 wherein the handwriting recognition engine receives a grammar and receives handwritten input symbols as digital ink, and from said digital ink and grammar the handwriting recognition engine generates an ordered list of results, each result being a text string that is considered valid by the recognition engine according to the grammar.

23. An input/output device for recognizing handwriting comprised of:
a touch-sensitive input pad on which handwritten input symbols can be made;
an output display screen having a text display/text input area on which text can be displayed;
a first computer, operatively coupled to the touch-sensitive input pad and to the output display screen,
said first computer being capable of receiving a first information signal from a second computer that specifies at least one input area on said touch-sensitive input pad into which a handwritten input symbol is to be entered, said first computer also being capable of receiving from said second computer, a grammar that is determined by text that is expected by the second computer to be entered into the text display/text input area and by which handwritten input symbols are to be converted to text by said first computer, said first computer also being capable of causing the display on said text display/text input area, text that was converted from a handwritten input symbol that was recognized by the first computer according to the grammar.

24. The input/output device of claim 23 wherein said first computer is capable of sending a first signal to the second computer that represents the text that was converted from a recognized handwritten input symbol by the first computer.

25. The input/output device of claim 23 wherein the information sent to said input/output device specifies a plurality of text display/text input areas, one or more text display/text input areas having a grammar for defining the text expected for the one or more text display/text input areas.

26. The input/output device of claim 23 wherein the computer is a computer that sends handwritten input symbols captured in the input area and the selected grammar, to a handwriting recognition engine for interpretation of the handwritten input symbols.

27. The input/output device of claim 26 wherein the handwriting recognition engine receives a grammar and receives handwritten input symbols as digital ink, and from said digital ink and grammar the handwriting recognition engine generates an ordered list of results, each result being a text string that is considered valid by the recognition engine according to the grammar.

28. A server, for recognizing handwriting, said server comprised of:
a computer operably coupled to a data network and receiving input signals from the network, said input signals representing handwritten input symbols, said computer having a recognition engine that converts the input signals representing handwritten symbols into text, using a grammar that is determined by text that said handwritten input symbols are expected to represent.

29. The server of claim 28 wherein the computer sends information to a handwriting input device via the data network and which specify a plurality of text display/text input areas, one or more text display/text input areas having a grammar for defining the text expected for the one or more text display/text input areas.

30. The server of claim 28 wherein the computer selects the grammar for a particular text display/text input area upon a user's selection of the text display/text input area for input.

31. The server of claim 28 wherein the computer receives handwritten input symbols captured in the input area and sends a grammar to a handwriting recognition engine for interpretation of the handwritten input symbols.

32. The server of claim 31 wherein the recognition engine receives a grammar and receives handwritten input symbols as digital ink, and from said digital ink and grammar the recognition engine generates an ordered list of results, each result being a text string that is considered valid by the recognition engine according to the grammar.

33. An input/output device for recognizing handwriting comprised of:
a touch-sensitive input pad on which handwritten input symbols can be made;
an output display screen on which graphics can be displayed in at least one text display/text input area;
a computer, operatively coupled to the touch-sensitive input pad and to the output display screen,
said computer containing information that specifies an input area on said touch-sensitive input pad into which a handwritten input symbol is to be entered, said computer also having a grammar that is determined by text that is expected by the computer to be entered into the at least one text display/text input area and by which handwritten input symbols are to be converted to text by said computer, said computer also being capable of causing the display on said output display screen, text that was converted from a handwritten input symbol that was recognized by the computer according to the grammar.

34. The device of claim 33 also having information that specifies a plurality of text display/text input areas, each of the text display/text input areas having a grammar for defining the text expected for the text display/text input area.

35. The device of claim 34 wherein the computer is a computer that selects the grammar for a particular text display/text input area upon a user's selection of a text display/text input area for input.
